(19) United States
(12) Patent Application Publication
(10) Pub. No.: US 2026/0347223 A1
(43) Pub. Date: Nov. 5, 2026

(54) SYSTEM FOR DENITRIFICATION, STERILIZATION, AND DECOLORING TREATMENT OF REARING WATER, AND METHOD FOR DENITRIFICATION, STERILIZATION, AND DECOLORING TREATMENT OF REARING WATER

(71) Applicants: National Institute of Technology, Hachioji-shi, Tokyo (JP); Yamatake Corp., Kuki-shi, Saitama (JP)

(72) Inventors: Takashi WATANABE, Ichinoseki (JP); Daigo YAMANAKA, Kuki (JP)

(73) Assignees: National Institute of Technology, Hachioji-shi, Tokyo (JP); Yamatake Corp., Kuki-shi, Saitama (JP)

(21) Appl. No.: 19/099,911

(22) PCT Filed: Aug. 2, 2023
(86) PCT No.: PCT/JP2023/028242

§ 371 Date: May 16, 2025

(30) Foreign Application Priority Data
Aug. 2, 2022 (JP) 2022-123403

(51) Int. Cl. C02F 1/78; A01K 63/04; C02F 1/00; C02F 101/16; C02F 101/30; C02F 103/20

(52) U.S. Cl. CPC C02F 1/78; A01K 63/042; A01K 63/045; C02F 1/004; C02F 2101/16; C02F 2101/308; C02F 2103/20; C02F 2301/046; C02F 2303/02; C02F 2303/04

(57) ABSTRACT

The invention relates to a system for a denitrification, sterilization and decolorization treatment of rearing water, including a rearing tank, a physical filtration tank, an ozone treatment tank, a mixing tank, a main circulation pump and an auxiliary circulation pump, wherein the mixing tank is installed behind the ozone treatment tank, the main circulation pump constantly circulates the rearing water through the rearing tank, the physical filtration tank, and the mixing tank, the auxiliary circulation pump circulates the rearing water through the rearing tank, the physical filtration tank, the ozone treatment tank, and the mixing tank, and when the auxiliary circulation pump is stopped, the treatment of the rearing water in the ozone treatment tank is performed in a batch manner, and when the auxiliary circulation pump is operated, the treatment of the rearing water in the ozone treatment tank is performed in a flow-through manner.

### TECHNICAL FIELD

The present invention relates to a system for denitrification, sterilization, and decolorization treatments of rearing water, which is useful for land-based closed recirculating aquaculture and rearing in aquarium of fishery products such as fish and shellfish and the like, and a method for efficiently performing denitrification, sterilization, and decolorization treatments of rearing water.

The present invention also relates to a system including a deodorization treatment and a plankton killing treatment of rearing water, in addition to denitrification, sterilization, and decolorization treatments of rearing water in land-based closed recirculating aquaculture and rearing in aquarium of fishery products such as fish and shellfish and the like, as well as a method for a deodorization treatment of rearing water and a method for a killing treatment of plankton in rearing water, in addition to efficient denitrification, sterilization, and decolorization treatments of rearing water.

### BACKGROUND ART

Among land-based aquaculture methods where fishery products such as fish and shellfish are reared and grown in water tanks installed on land, land-based closed recirculating aquaculture in which rearing water is repeatedly utilized upon purification can produce fishery products with a consistent level of quality, without being affected by natural disasters such as typhoons and tsunamis, or by global warming. Furthermore, if artificial seawater or ion-exchanged water is used as the rearing water, there is no concern about red tides, the occurrence of parasites, contamination by microplastics or contaminant substances, offering advantages that cannot be realized by sea-surface aquaculture, which is currently the mainstream method of aquaculture.

In the purification of rearing water in land-based closed recirculating aquaculture, the decomposition of ammonium-nitrogen excreted from fish and shellfish is important. Currently, the decomposition of ammonium-nitrogen is mainly performed by nitrification using ammonia oxidizing bacteria and nitrite oxidizing bacteria by using biological filtering materials. However, the proportion of biological filtering materials in the entire aquaculture system is large, thus problematically lowering the production volume of fish and shellfish per system. In addition to decomposition of ammonium-nitrogen, purification of rearing water requires the sterilization of harmful microorganisms to prevent diseases in fish and shellfish, and the decomposition (clarification) of coloring components such as humic acid to monitor fish and shellfish by using AI cameras. However, biological filtering materials cannot perform these processes and ultraviolet sterilization device, activated carbon treatment device, and the like need to be installed separately, which further reduces the production amount. Furthermore, since biological filtering materials are sensitive to changes in the environment and difficult to handle, problems occur when a denitrification tank is absent that nitrates will accumulate and the rearing water needs to be ultimately exchanged.

In order to improve the profitability of land-based aquaculture systems, it is necessary to rear and grow fishery products such as fish and shellfish at high densities. Such rearing requires a system that can perform more advanced decomposition of ammonium-nitrogen, and sterilization and decolorization treatments of the rearing water.

As an alternative to biological filtering materials, a technique has been proposed for more efficiently decomposing ammonium-nitrogen, in which a bromine compound that generates bromine ions is added to water containing ammonium-nitrogen, a gas containing ozone is injected into the water to which the aforementioned bromine compound has been added, the ozone added to water is reacted with the bromine ions added to the water to generate oxidizing substances, and the generated oxidizing substances decompose the ammonium-nitrogen (Patent Literature 1, Non Patent Literature 1).

The above-mentioned oxidizing substances are powerful oxidizing agents, and capable of performing denitrification, sterilization, and decolorization treatments. However, since they have strong biological toxicity, the concentration of the remaining oxidizing substances needs to be reduced to 0.05 mg/L or less in order to ensure absence of biological effects.

In the water treatment methods described in Patent Literature 1 and Non Patent Literature 1, the treatment system is in a simple flow-through manner, which makes it difficult to maintain the oxidizing substances at concentrations necessary for the decomposition of ammonium-nitrogen, sterilization and decolorization, and also poses problems in that unreacted oxidizing substances remain easily and a separate decomposition process of the remaining oxidizing substances with activated carbon becomes necessary.

Therefore, as a method for reducing the remaining oxidizing substances in the treatment of wastewater containing ammonium-nitrogen, a method has been proposed in which a mixing tank is installed before the ozone treatment tank, a part of the treated water containing the oxidizing substances after ozone treatment is returned to the mixing tank and mixed with the wastewater containing ammonium-nitrogen, thereby causing a reaction between the oxidizing substances and the ammonium-nitrogen and reducing the remaining oxidizing substances (Patent Literature 2).

However, even in the method proposed in Patent Literature 2, since oxidizing substances remain in the treated water discharged from the ozone treatment tank, a treatment with activated carbon is ultimately required. Furthermore, in the method proposed in Patent Literature 2, since the wastewater treatment is performed in a flow-through manner, the flow rate of the treated water must be slow in order to efficiently perform denitrification, sterilization, and decolorization, which makes it difficult to apply the method to land-based closed recirculating aquaculture or rearing in aquariums because they require a large amount of rearing water.

Therefore, there is a demand for a system for denitrification, sterilization, and decolorization treatments of rearing water that can simultaneously achieve the decomposition of ammonium-nitrogen in rearing water and sterilization and decolorization treatments of rearing water by a high-concentration ozone treatment; and the reduction of the remaining amount of oxidizing substances in the treated water after the aforementioned treatments, and that can be easily applied to land-based closed recirculating aquaculture and rearing in aquariums, which require large amounts of rearing water.

### CITATION LIST

### Patent Literature

### [Patent Literature 1]

JP H3-181390 A

### [Patent Literature 2]

JP H7-195087 A

### [Non Patent Literature]

### [Non Patent Literature 1]

Journal of the Japanese Society for Antibacterial and Antifungal Agents 42 (4) 207-212 (2014)

### SUMMARY OF INVENTION

### Technical Problem

Therefore, the present invention aims to provide a treatment system that can simultaneously achieve a high-concentration ozone treatment that can efficiently perform decomposition of ammonium-nitrogen in rearing water and sterilization and decolorization of rearing water; and the reduction of oxidizing substances remaining in the treated water after the aforementioned treatments, and that can be applied to land-based closed recirculating aquaculture and rearing in aquariums, which require large amounts of rearing water.

### Solution to Problem

The present inventors have conducted intensive studies in an attempt to solve the aforementioned problems and found that decomposition of ammonium-nitrogen in the rearing water, namely, a denitrification treatment, and reduction of the concentration of oxidizing substances remaining in the treated water after the denitrification treatment, can be efficiently performed by configuring a system for denitrification, sterilization, and decolorization treatments of rearing water to include a rearing tank, a physical filtration tank, an ozone treatment tank, a mixing tank installed behind the ozone treatment tank, a main circulation pump that circulates the rearing water through the rearing tank, the physical filtration tank, and the mixing tank, and an auxiliary circulation pump that circulates the rearing water through the rearing tank, the physical filtration tank, the ozone treatment tank, and the mixing tank, and switching the treatment in the ozone treatment tank in a flow-through manner or a batch manner depending on the presence or absence of the operation of the auxiliary circulation pump. They have conducted further studies and completed the present invention.

Also, the present inventors have found that a sterilization treatment and a decolorization treatment of rearing water, and further, a deodorization treatment and a plankton killing treatment of rearing water can be performed in addition to the efficient performance of the denitrification treatment of rearing water, and reduction of the concentration of oxidizing substances remaining in the treated water after the denitrification treatment, by switching the treatment in the ozone treatment tank in a flow-through manner or a batch manner depending on the presence or absence of the operation of the auxiliary circulation pump in the above-mentioned configuration.

That is, the present invention relates to the following.
[1] A system for a denitrification, sterilization and decolorization treatment of rearing water, including a rearing tank, a physical filtration tank, an ozone treatment tank, a mixing tank, a main circulation pump and an auxiliary circulation pump, wherein the mixing tank is installed behind the ozone treatment tank, the main circulation pump is a pump that constantly circulates the rearing water through the rearing tank, the physical filtration tank, and the mixing tank, the auxiliary circulation pump is a pump that circulates the rearing water through the rearing tank, the physical filtration tank, the ozone treatment tank, and the mixing tank, and when the auxiliary circulation pump is stopped, the treatment of the rearing water in the ozone treatment tank is performed in a batch manner, and when the auxiliary circulation pump is operated, the treatment of the rearing water in the ozone treatment tank is performed in a flow-through manner.
[2] The system of [1], wherein the ozone treatment tank has an ozone supply device capable of supplying ozone fine bubbles.
[3] The system of [2], wherein the ozone supply device capable of supplying ozone fine bubbles is configured by connecting a fine bubble generating device composed of a fine bubble generating nozzle and a magnet pump to an ozone generator.
[4] The system of any of [1] to [3], wherein an ozone treatment tank and a mixing tank separated by a partition are installed above the rearing tank, the height of the partition is set higher than the water surface of the rearing water in the mixing tank, and when the auxiliary circulation pump is operated, the rearing water flows from the ozone treatment tank over the partition and into the mixing tank.
[5] The system of [4], wherein the ozone treatment tank and the mixing tank separated by the partition form an overflow water tank, and the mixing tank is connected to the rearing tank by an overflow pipe.
[6] A method for treating rearing water, comprising, in a system for denitrification, sterilization, and decolorization treatments of rearing water, comprising a rearing tank, a physical filtration tank, an ozone treatment tank, a mixing tank installed behind the ozone treatment tank, a main circulation pump, and an auxiliary circulation pump, while constantly circulating the rearing water through the rearing tank, the physical filtration tank, and the mixing tank using the main circulation pump, stopping the operation of the auxiliary circulation pump that circulates the rearing water through the rearing tank, the physical filtration tank, the ozone treatment tank, and the mixing tank, treating the rearing water in the ozone treatment tank in a batch manner, operating the auxiliary circulation pump to treat the rearing water in the ozone treatment tank in a flow-through manner, and mixing the treated water after ozone treatment in the ozone treatment tank with rearing water circulated to the mixing tank by the main circulation pump to reduce oxidizing substances in the treated water in the ozone treatment tank and denitrify ammonium-nitrogen in the rearing water.
[7] The treatment method of [6], wherein the ozone treatment of the rearing water is performed using ozone fine bubbles.
[8] The treatment method of [7], wherein the ozone fine bubbles are supplied by an ozone supply device configured by connecting a fine bubble generating device composed of a fine bubble generating nozzle and a magnet pump to an ozone generator.
[9] The treatment method of any of [6] to [8], wherein the system for denitrification, sterilization, and decolorization of rearing water is a system in which an ozone treatment tank and a mixing tank separated by a partition are installed above the rearing tank, the height of the partition is set higher than the water surface of the rearing water in the mixing tank, and when the auxiliary circulation pump is operated, the rearing water flows from the ozone treatment tank over the partition and into the mixing tank.
[10] The treatment method of [9], wherein, in the system for denitrification, sterilization, and decolorization of rearing water, the ozone treatment tank and the mixing tank separated by the partition form an overflow water tank, and the mixing tank is connected to the rearing tank by an overflow pipe.
[11] The system of any of [1] to [5], which is a deodorizing treatment system for the rearing water.
[12] The system of any of [1] to [5], which is a treatment system for killing plankton in the rearing water.
[13] The treatment method of any of [6] to [10], further comprising a sterilization treatment of the rearing water.
[14] The treatment method of any of [6] to [10], further comprising a decolorization treatment of the rearing water.
[15] The treatment method of any of [6] to [10], further comprising a deodorization treatment of the rearing water.
[16] The treatment method of any of [6] to [10], further comprising a killing treatment of plankton in the rearing water.

### Advantageous Effects of Invention

According to the present invention, a system for denitrification, sterilization, and decolorization treatments of rearing water can be provided that can simultaneously achieve a high-concentration ozone treatment capable of efficiently performing decomposition of ammonium-nitrogen in rearing water, and sterilization and decolorization of rearing water; and reduction of the oxidizing substances remaining in the treated water after the aforementioned ozone treatment, and that can efficiently perform removal of ammonium-nitrogen in rearing water and sterilization and clarification of rearing water even under the environment where fish and shellfish are reared at high density.

Furthermore, according to the system for denitrification, sterilization, and decolorization treatments of rearing water of the present invention, a deodorization treatment of rearing water and a plankton killing treatment of rearing water can be efficiently performed in addition to the denitrification, sterilization, and decolorization treatments of rearing water.

Therefore, the system for denitrification, sterilization, and decolorization treatments of rearing water of the present invention, as well as the system of the present invention for denitrification, sterilization, decolorization, deodorization of rearing water, and plankton killing treatment of rearing water can be preferably used for land-based closed recirculating aquaculture and rearing in aquariums, which require large amounts of rearing water.

### BRIEF DESCRIPTION OF DRAWINGS

FIG. 1 is a diagram showing an outline of the system for denitrification, sterilization, and decolorization treatments of rearing water of the present invention.

FIG. 2 is a diagram showing the configuration of the system for denitrification, sterilization, and decolorization treatments of rearing water in a preferred embodiment of the present invention.

FIG. 3 is a diagram showing the configuration of the system for denitrification, sterilization, and decolorization treatments of rearing water in Example 1 of the present invention.

FIG. 4 is a diagram showing the relationship between the oxidant concentration of rearing water and the proportion of dead cells of plankton (Chaetoceros gracilis) in the killing treatment of plankton in rearing water by the system for denitrification, sterilization, and decolorization treatments of rearing water in Example 1 of the present invention.

### DESCRIPTION OF EMBODIMENTS

The present invention provides a system for denitrification, sterilization, and decolorization treatments of rearing water (hereinafter also to be referred to as “the system of the present invention” in the present specification). The system of the present invention includes a rearing tank, a physical filtration tank, an ozone treatment tank, and a mixing tank, and also includes a main circulation pump and an auxiliary circulation pump as pumps that circulate the rearing water between these tanks.

The rearing tank in the system of the present invention is a water tank used for rearing fishery products such as fish and shellfish, and the shape, material, and the like thereof are not particularly limited as long as they are generally used in land-based closed recirculating aquaculture and the like. Examples include those made of glass, plastic resin (acrylic resin, and the like), fiber reinforced plastic (FRP), and the like and having a cylindrical shape, an elliptical shape, a rectangular shape, and the like. The size of the rearing tank can be set appropriately depending on the amount of fishery products to be reared, the scale of rearing, and the like.

As the rearing water, seawater, artificial seawater, freshwater added with bromine ion, brackish water made by diluting seawater, and the like can be used depending on the type of fishery products to be reared.

A rearing tank having a water temperature control device and an oxygen supply device is preferred.

The physical filtration tank in the system of the present invention has a function of physically filtering off excrement, leftover food and the like in the rearing water, and those generally used can be adopted without any particular limitation. The shape and material of the tank that constitutes the physical filtration tank can be those used generally, and examples thereof include those made of glass, plastic resin (acrylic resin, and the like), fiber reinforced plastic (FRP), and the like and having a cylindrical shape, an elliptical shape, a rectangular shape, and the like. The size thereof is set appropriately depending on the amount of fishery products to be reared, the scale of rearing, and the amount of rearing water to be treated.

As a physical filtering material, polyester wool mat, polyether sponge, filter gravel, anthracite, and the like can be preferably used.

The ozone treatment tank in the system of the present invention has an ozone supply device. The shape and material of the tank that constitutes the ozone treatment tank can be those generally used for ozone treatment of rearing water, and examples thereof include those made of glass, plastic resin (acrylic resin, and the like), fiber reinforced plastic (FRP), and the like and having a cylindrical shape, an elliptical shape, a rectangular shape, and the like. The size thereof is set appropriately depending on the amount of fishery products to be reared, the scale of rearing, and the amount of rearing water to be treated.

The ozone supply device is not particularly limited as long as it is a device that can aerate ozone generated by a commercially available ozone generator into the rearing water to be treated that has been sent to an ozone treatment tank, and one that can supply ozone fine bubbles is preferably used. An ozone supply device capable of supplying ozone fine bubbles is, for example, produced by connecting a fine bubble generating device composed of a fine bubble generating nozzle and a magnet pump to an ozone generator.

The fine bubble generating nozzle and magnet pump that constitute the fine bubble generating device can each be commercially available products, and appropriate ones can be selected and used depending on the size of the ozone treatment tank, the amount of rearing water to be treated, and the like. In addition, as the commercially available ozone generator to be connected to the fine bubble generating device, one that can generate the required amount of ozone can be appropriately selected and used depending on the amount of rearing water to be treated, and the like.

The ozone fine bubbles supplied by the above-mentioned ozone supply device have an average bubble diameter of about 20 μm to 100 μm. For efficient denitrification treatment, the average bubble diameter is preferably about 20 μm to 50 μm. The average bubble diameter of the ozone fine bubbles can be measured by a laser diffraction/scattering method using a laser diffraction particle size analyzer or the like.

The mixing tank in the system of the present invention is a tank in which the ozone-treated water sent from the ozone treatment tank after ozone treatment and containing remaining oxidizing substances is mixed with the rearing water containing ammonium-nitrogen that is discharged from the rearing tank and sent through a physical filtration tank.

The shape and material of the mixing tank can be the same as those of the ozone treatment tank, and the size thereof can be appropriately set depending on the amount of ozone-treated water containing remaining oxidizing substances, the amount of rearing water to be mixed, and the like.

In the system of the present invention, the mixing tank is installed behind the ozone treatment tank.

In the system of the present invention, the main circulation pump sends rearing water from the rearing tank to the mixing tank via the physical filtration tank, and then sends the rearing water from the mixing tank to the rearing tank, thereby circulating the rearing water between the rearing tank and the physical filtration tank, between the physical filtration tank and the mixing tank, and between the mixing tank and the rearing tank.

On the other hand, the auxiliary circulation pump sends rearing water from the rearing tank to the mixing tank via the physical filtration tank and the ozone treatment tank, and then sends the rearing water from the mixing tank to the rearing tank, thereby circulating the rearing water between the rearing tank and the physical filtration tank, between the physical filtration tank and the ozone treatment tank, between the ozone treatment tank and the mixing tank, and between the mixing tank and the rearing tank.

In the present invention, any pumps can be used, without any particular limitation, as the main circulation pump and the auxiliary circulation pump, as long as they are generally used for sending water between tanks in land-based closed recirculating aquaculture and the like, and commercially available pumps can be selected and used appropriately depending on the volume of each tank, the amount of water to be sent, and the like.

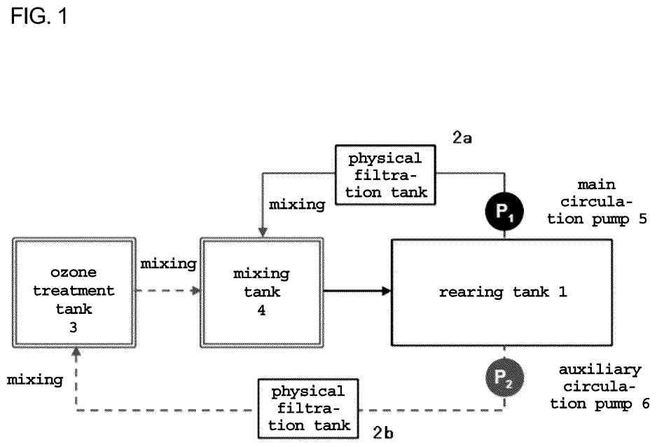

An outline of the system of the present invention is shown in FIG. 1. In the system of the present invention, the rearing water is circulated by the main circulation pump (5) from the rearing tank (1) through the physical filtration tank (2a) and the mixing tank (4) to the rearing tank (1) in FIG. 1. On the other hand, the rearing water is circulated by the auxiliary circulation pump (6) from the rearing tank (1) through the physical filtration tank (2b), the ozone treatment tank (3), and the mixing tank (4) to the rearing tank (1).

When subjecting the rearing water through the physical filtration tank to denitrification, sterilization, and decolorization treatments in the ozone treatment tank (3), the operation of the auxiliary circulation pump (6) is stopped and the rearing water is treated in a batch manner in the ozone treatment tank (3), whereby the oxidizing substances generated in the ozone treatment tank (3) is made to have a high concentration, and decomposition of ammonium-nitrogen in the rearing water, and sterilization and decolorization treatments of the rearing water can be performed efficiently.

Then, when the auxiliary circulation pump (6) is operated, the treated water after the denitrification, sterilization, and decolorization treatments is sent from the ozone treatment tank (3) to the mixing tank (4). By constantly operating the main circulation pump (5), rearing water with a high ammonium-nitrogen content is constantly sent to the mixing tank (4) from the rearing tank (1) via the physical filtration tank (2a). Thus, the treated water with remaining oxidizing substances which is sent from the ozone treatment tank (3) is mixed with the aforementioned rearing water with a high ammonium-nitrogen content, and the remaining oxidizing substances react with the ammonium-nitrogen in the mixing tank (4).

As a result, the concentration of the oxidizing substances remaining in the treated water after the denitrification, sterilization, and decolorization treatments in the ozone treatment tank (3) can be reduced, and the denitrification, sterilization, and decolorization treatments of the rearing water sent from the rearing tank (1) can be performed, whereby the ammonium-nitrogen in the rearing water is decomposed, the rearing water is sterilized, and decolorized, as well as the rearing water with remaining oxidizing substances in reduced amounts can be returned to the rearing tank (1).

The system of the present invention can include devices and the like generally used in land-based closed recirculating aquaculture and the like, such as a foam separator, an ultraviolet sterilizer, a water tank cooler, a water tank heater, a calcium reactor, and the like, as long as the features of the present invention are not impaired.

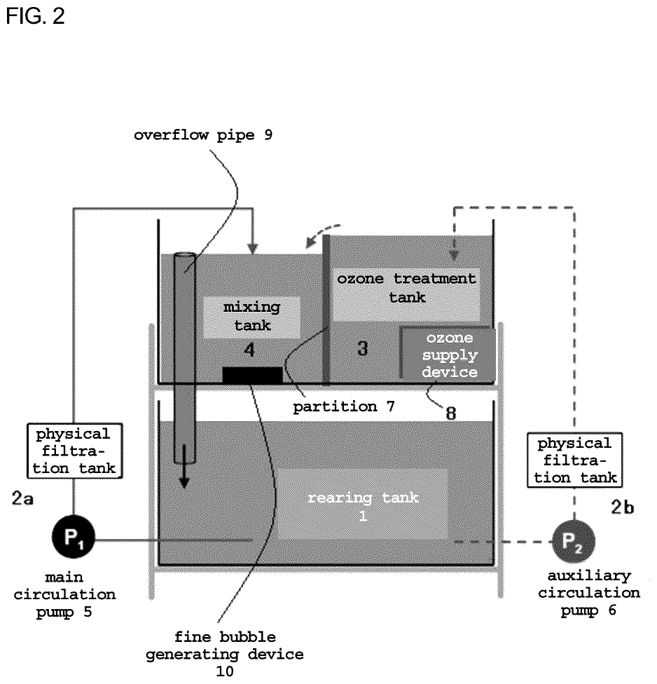

As a preferred embodiment of the present invention, the system of the present invention can be configured as shown in FIG. 2, in which an ozone treatment tank (3) and a mixing tank (4) separated by a partition (7) are installed above a rearing tank (1), rearing water is circulated between the rearing tank (1) and the mixing tank (4) by a main circulation pump (5) via a physical filtration tank (2a), and rearing water is circulated between the rearing tank (1) and the ozone treatment tank (3) by an auxiliary circulation pump (6) via a physical filtration tank (2b).

The partition (7) is preferably made of plastic such as acrylic resin or fiber reinforced plastic (FRP), and the height of the partition (7) is set slightly higher than the water surface of the rearing water in the mixing tank (4).

When the rearing water sent to the ozone treatment tank (3) by the auxiliary circulation pump (6) exceeds the partition (7), the rearing water flows from the ozone treatment tank (3) into the mixing tank (4). The outlet pipe on the auxiliary circulation pump (6) side is installed at the height of the water surface corresponding to the volume of rearing water to be denitrified, sterilized, and decolorized in the ozone treatment tank (3).

In the system of this embodiment, when the operation of the auxiliary circulation pump (6) is stopped, the siphon principle works, and the rearing water in the ozone treatment tank (3) flows back into the rearing tank (1) side, the water surface drops to the position of the outlet pipe, and the backflow automatically stops.

Therefore, by stopping the operation of the auxiliary circulation pump (6), only the treatment in the ozone treatment tank (3) can be performed in a batch manner.

After the backflow of the rearing water has completely stopped, the ozone supply device (8) is operated, and the oxidizing substances produced by the generated ozone can efficiently decompose the ammonium-nitrogen in the rearing water and sterilize and decolorize the rearing water.

Then, when the auxiliary circulation pump (6) is operated, the rearing water containing ammonium-nitrogen flows from the rearing tank (1) into the ozone treatment tank (3) via the physical filtration tank (2b), reacts with the high-concentration oxidizing substances remaining in the treated water in the ozone treatment tank (3), and reduces the concentration of the oxidizing substances. Successively, the water surface of the treated water in the ozone treatment tank (3) rises, and the treated water in the ozone treatment tank (3) flows over the partition (7) into the mixing tank (4). The treated water containing oxidizing substances that has flown in from the ozone treatment tank (3) reacts with the ammonium-nitrogen-containing rearing water supplied to the mixing tank (4) by the main circulation pump (5), whereby the concentration of the oxidizing substances in the treated water that has flown in from the ozone treatment tank (3) can be reduced to a level free of biological problems. Since the ammonium-nitrogen-containing rearing water in the rearing tank (1) is continuously supplied to the mixing tank (4) by the main circulation pump (5), the oxidizing substances are reduced more effectively.

The mixing tank (4) and the rearing tank (1) can be configured as shown in FIG. 2 in which they are connected using an overflow pipe (9), and when the water surface in the mixing tank (4) becomes higher than the upper end of the overflow pipe (9), the denitrified rearing water falls from the overflow pipe (9) into the rearing tank (1).

In the mixing tank (4), it is more preferable to install a fine bubble generating device (10) or the like and perform an aeration treatment for the purpose of effective denitrification reaction and supply of oxygen to the rearing tank (1).

The above-mentioned fine bubble generating device (10) may be one generally used for aeration treatment of rearing water, and is exemplified by one composed of a fine bubble generating nozzle and a submersible pump. As the fine bubble generating nozzle and submersible pump, commercially available products can be utilized depending on the size of the mixing tank or rearing tank, the amount of rearing water, and the like.

It is preferable to use a fine bubble generating device (10) that can generate fine bubbles with an average bubble diameter of about 80 μm to 100 μm. The average bubble diameter of the fine bubbles can be measured by a laser diffraction/scattering method using a laser diffraction particle size analyzer or the like.

The control of operation and stop of the auxiliary circulation pump (6) and the ozone supply device (8) can be conveniently performed using a program timer.

The system of the present invention can simultaneously achieve a high-concentration ozone treatment capable of efficiently performing decomposition of ammonium-nitrogen in rearing water, and sterilization and decolorization treatments of rearing water; and reduction of the oxidizing substances remaining in the treated water, and can efficiently perform removal of ammonium-nitrogen in rearing water and sterilization and clarification treatments of rearing water even under the environment where fishery products such as fish and shellfish are reared at high density.

Furthermore, the system of the present invention can efficiently perform a deodorization treatment and a plankton killing treatment of rearing water, in addition to denitrification, sterilization, and decolorization treatments of rearing water.

Therefore, the system for denitrification, sterilization, and decolorization treatments of rearing water of the present invention, as well as the system of the present invention for denitrification, sterilization, decolorization, deodorization of rearing water, and plankton killing treatment of rearing water are systems more useful for land-based closed recirculating aquaculture of fishery products and rearing of fishery products in aquariums, which require large amounts of rearing water.

In addition, the present invention provides a method for efficient denitrification, sterilization, and decolorization treatments of rearing water, in land-based closed recirculating aquaculture and the like (hereinafter also to be referred to as “the method of the present invention” in the present specification).

The method of the present invention includes, in a system for denitrification, sterilization, and decolorization treatments of rearing water, containing the rearing tank, a physical filtration tank, the ozone treatment tank, the mixing tank installed behind the ozone treatment tank, a main circulation pump, and the auxiliary circulation pump, while constantly circulating the rearing water through the rearing tank, the physical filtration tank, and the mixing tank using the main circulation pump, stopping the operation of the auxiliary circulation pump that circulates the rearing water through the rearing tank, the physical filtration tank, the ozone treatment tank, and the mixing tank, treating the rearing water in the ozone treatment tank in a batch manner, operating the auxiliary circulation pump to treat the rearing water in the ozone treatment tank in a flow-through manner, and mixing the treated water after ozone treatment in the ozone treatment tank with rearing water circulated to the mixing tank by the main circulation pump to reduce oxidizing substances in the treated water in the ozone treatment tank and denitrify ammonium-nitrogen in the rearing water.

The rearing tank, physical filtration tank, ozone treatment tank, mixing tank, main circulation pump, and auxiliary circulation pump used in the method of the present invention are as described above for the system of the present invention. The batch manner treatment and flow-through manner treatment of rearing water in the ozone treatment tank, as well as the switching between the aforementioned treatments by operating and stopping the auxiliary circulation pump, are also as described above for the system of the present invention.

The method of the present invention can efficiently perform decomposition of ammonium-nitrogen in rearing water, and sterilization and decolorization treatments of rearing water, as well as efficiently reduce oxidizing substances remaining in the treated water, and can efficiently perform removal of ammonium-nitrogen in rearing water, namely, denitrification treatment, and sterilization and clarification treatments of rearing water even under the environment where fishery products such as fish and shellfish are reared at high density.

According to the method of the present invention, moreover, a deodorization treatment of rearing water and a killing treatment of plankton in rearing water can be efficiently performed, in addition to the removal of ammonium-nitrogen in rearing water, namely, a denitrification treatment, and sterilization and clarification treatments of rearing water.

### EXAMPLE

The present invention is described in further detail below with reference to Examples.

### [Example 1] System for Denitrification, Sterilization, and Decolorization Treatments of Rearing Water, and Denitrification Treatment of Rearing Water

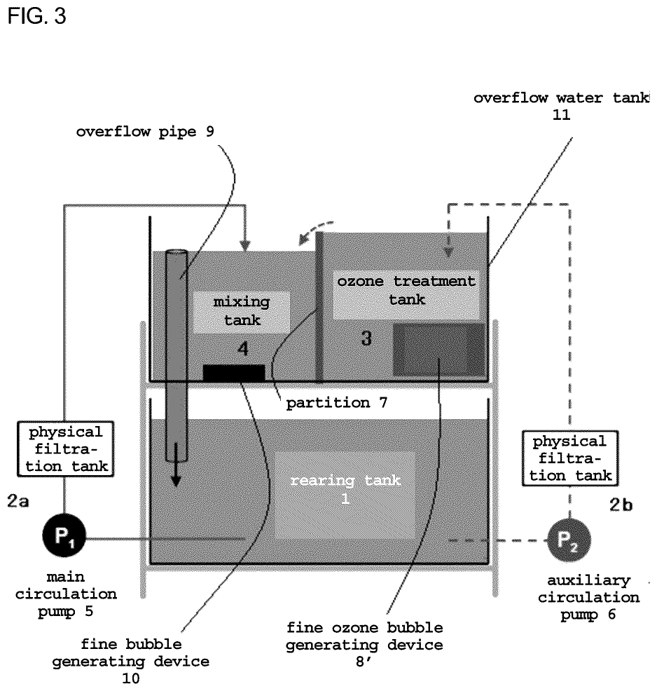

FIG. 3 shows the basic configuration of the treatment system of this Example.

A normal acrylic resin water tank with external dimensions of 900 mm×450 mm×450 mm was used as the rearing tank (1), and an acrylic resin overflow water tank (11) of the same size was used as the ozone treatment tank (3) and the mixing tank (4). The rearing tank (1) was placed at the bottom of a water tank stand, and the overflow water tank (11) was placed at the top thereof. In the aforementioned overflow water tank (11), the height from the bottom surface of the water tank to the top of the overflow pipe (9) was 380 mm, and an acrylic resin partition (7) with a height of 410 mm was installed in the center. The aforementioned overflow water tank (11) was placed on the rearing tank (1) and the mixing tank (4) and the rearing tank (1) were connected by the overflow pipe (9).

The rearing water was 280 L of 3.5 wt % artificial seawater (“Red Sea Salt”, manufactured by MMC PLANNING Co. Ltd.). A submersible pump (“Newa Jet NJ3000”, manufactured by NEWA) was used as the main circulation pump (5) to circulate the rearing water, and a submersible pump (“Newa Jet NJ1700”, manufactured by NEWA) was used as the auxiliary circulation pump (6).

The main circulation pump (5) was connected to an external filtration tank (“MEGA Power 6090”, manufactured by GEX Corporation) and a water tank cooler (“COOLWAY 400”, manufactured by GEX Corporation) as the physical filtration tank (2a), and circulation was performed from the rearing tank (1) to the mixing tank (4). On the other hand, only an external filtration tank (“MEGA Power 6090”, manufactured by GEX Corporation) was connected to the auxiliary circulation pump (6) as the physical filtration tank (2b), and circulation was performed from the rearing tank (1) to the ozone treatment tank (3) and the mixing tank (4). The flow rate of the both circulation pumps was about 4 L/min (adjusted by a cock), and the temperature of the rearing water was maintained at 20 °C. A polyester mat and a polyether sponge were placed in the above mentioned external filtration tank to form a physical filtration tank.

The outlet pipe of the auxiliary circulation pump (6) was set to make the amount of treated water in the ozone treatment tank (3) 60 L.

In order to test the denitrification function of the treatment system of this Example, ammonium chloride was added to the rearing water to an ammonium-nitrogen concentration of about 0.5 ppm, and the rearing water was circulated from the rearing tank (1) to the ozone treatment tank (3) and the mixing tank (4) as described above by the main circulation pump (5) and the auxiliary circulation pump (6).

In the ozone treatment tank (3), as an ozone supply device (8), an ozone fine bubble supply device (8′) was installed which was produced by connecting a water-cooled ozone generator for research and development (“LABOZONE 15 LOG-LC15G” manufactured by EcoDesign, Inc.) to a self-priming port of a fine bubble generating device consisting of a fine bubble generating nozzle (“LOOP-FLOW OK NOZZLE OKE-MB04FJ” manufactured by OK Engineering Co., Ltd.) and a magnet pump (“IWAKI Small Magnet Pump MD-40RZ-N” manufactured by IWAKI CO., LTD.). Oxygen gas from an oxygen cylinder was used as the raw material for ozone, and ozone gas was supplied under the conditions of a raw oxygen gas flow rate of 0.15 L/min and an ozone generation rate of 2.4 g/hr to generate ozone fine bubbles with an average bubble diameter of about 100 μm. The aforementioned average bubble diameter of the ozone fine bubbles was measured by laser diffraction particle size distribution measurement.

For the purpose of effective denitrification reaction and supply of oxygen to the rearing tank (1), a fine bubble generating device (10) consisting of a fine bubble generating nozzle (“LOOP-FLOW OK NOZZLE OK-MB04FJ” manufactured by OK Engineering Co., Ltd.) and a submersible pump (“Brush-less DC submersible pump M6SP-A10-02”, manufactured by Putio LTD.) was housed and operated in the mixing tank (4). The gas self-sucked by the aforementioned fine bubble generating device (10) was air, and the air flow rate was 0.15 L/min. The average bubble diameter of the generated fine bubbles was 80 μm to 100 μm, as determined by laser diffraction particle size distribution measurement.

When ozone treatment of the ammonium-nitrogen-containing rearing water in the rearing tank (1) was performed, the operation of the auxiliary circulation pump (6) was first stopped, whereby the rearing water in the ozone treatment tank (3) was allowed to flow back into the rearing tank (1) by the siphon principle until the surface of the treated water in the ozone treatment tank (3) reached the tip of the outlet pipe of the auxiliary circulation pump (6). In this Example, the amount of rearing water in the ozone treatment tank (3) reached about 60 L due to this backflow. When this backflow stops, the rearing water remaining in the ozone treatment tank (3) becomes independent of the circulation by the main circulation pump (5) and temporarily enters a batch state.

Successively, ozone fine bubbles were generated in the rearing water in the ozone treatment tank (3) by the ozone fine bubble supply device (8′) under the above-mentioned conditions, and the treatment was performed for 10 minutes. During ozone treatment, unreacted ozone gas which was released onto the water surface was decomposed using an ozone decomposer (In-line ozone decomposer ED-MD9-500S, manufactured by EcoDesign, Inc.).

After ozone treatment, the operation of the auxiliary circulation pump (6) was resumed, and the ozone treatment tank (3) was put back into a flow-through state again. The treated water in the ozone treatment tank (3) flowed into the mixing tank (4) over the partition (7), and was mixed with the rearing water circulated in the mixing tank (4) by the main circulation pump (5), and then discharged from the overflow pipe (9) into the rearing tank (1). 90 minutes after the circulation by the auxiliary circulation pump (6) became complete, the rearing water in the rearing tank (1) was collected, the concentration of oxidizing substance in the rearing water was quantified by the o-tolidine method, the concentration of ammonium-nitrogen in the rearing water was quantified by the salicylic acid method, and the concentration of nitrate-nitrogen in the rearing water was quantified by the cadmium reduction method. The quantification results are shown in Table 1.

TABLE 1

| quantified item | quantification results | |
|---|---|---|
| oxidizing substance | 0.039 | mg/L |
| (converted to ozone | | |
| concentration) | | |
| ammonium-nitrogen | 0.32 | ppm |

| | |
|---|---|
| nitrate-nitrogen | below detection limit |

As shown in Table 1, the concentration of the oxidizing substance in the rearing water was 0.039 mg/L when converted to ozone concentration, which is not more than 0.05 mg/L considered to be free of biological problems. The concentration of the oxidizing substance in the ozone treatment tank (3) immediately after completion of the ozone treatment was 1.1 mg/L in ozone concentration. If this treated water flows directly into the rearing tank (1), the ozone concentration in the rearing tank (1) is expected to easily exceed 0.05 mg/L. It was demonstrated that the system of Example 1 can efficiently reduce the concentration of oxidizing substances after ozone treatment.

As shown in Table 1, moreover, the concentration of ammonium-nitrogen decreased to 0.32 ppm, and it was demonstrated that a more effective denitrification treatment of ammonium-nitrogen is possible by adding the contribution of denitrification that proceeds in a flow-through manner to the denitrification in a batch manner, since denitrification treatment only in a batch manner theoretically achieves reduction to 0.40 ppm. The nitrate-nitrogen concentration was always below detection limit.

Furthermore, since the concentration of oxidizing substances in the ozone treatment tank (3) immediately after completion of the above-mentioned ozone treatment was 1.1 mg/L in terms of ozone concentration, effective sterilization and decolorization treatment of the rearing water can be achieved by performing ozone treatment of the rearing water in the ozone treatment tank (3).

The above-mentioned results of denitrification treatment of the rearing water using the system of Example 1 suggest that the optimal conditions for rearing water containing 0.5 ppm of ammonium-nitrogen in the system of the present invention are to set the concentration of oxidizing substances in the ozone treatment tank (3) to about 1.1 ppm in terms of ozone concentration and to perform the treatment for 10 minutes.

### [Example 2] Denitrification Treatment of Rearing Water

In the treatment system of Example 1, the rearing water was treated in the same manner as in the denitrification treatment in Example 1, except that the ammonium-nitrogen concentration in the rearing water was 1 ppm and the ozone treatment time was 15 minutes. As in the case of the treatment in Example 1, 90 minutes after the circulation by the auxiliary circulation pump (6) reached full circulation, the rearing water in the rearing tank (1) was collected and the concentrations of oxidizing substances, ammonium-nitrogen, and nitrate-nitrogen in the rearing water were measured. The measurement results are shown in Table 2.

TABLE 2

| quantified item | quantification results | |
|---|---|---|
| oxidizing substance | 0.030 | mg/L |
| (converted to ozone | | |
| concentration) | | |
| ammonium-nitrogen | 0.73 | ppm |

| | |
|---|---|
| nitrate-nitrogen | below detection limit |

The concentration of oxidizing substances in the ozone treatment tank (3) immediately after completion of the ozone treatment was as high as 1.9 mg/L in terms of ozone concentration. As shown in Table 2, however, the concentration of oxidizing substance in the rearing water after the denitrification treatment in Example 2 was 0.030 mg/L in terms of ozone concentration, and a drastic decrease to a level free of biological problems was found. In addition, the concentration of ammonium-nitrogen was 0.73 ppm, and it was found that ammonium-nitrogen was more effectively denitrified when the concentration of ammonium-nitrogen in the rearing water was 1 ppm, even though the ozone treatment time of 15 minutes was not the optimal condition. In the denitrification treatment of this Example, nitrate-nitrogen was also below detection limit.

### [Example 3] Sterilization Treatment of Rearing Water

In the treatment system of Example 1, ozone treatment was performed by generating ozone fine bubbles to an oxidant concentration in the rearing water of 3.92 mg/L in terms of ozone concentration, by using the ozone fine bubble generating device (8′) for 60 L of rearing water in the ozone treatment tank (3). This treated water was sampled and diluted with artificial seawater, that had been sterilized by filtration without ozone treatment, to each oxidant concentration (in terms of ozone concentration) of 2.0 mg/L, 1.5 mg/L, 1.0 mg/L, 0.5 mg/L, or 0.1 mg/L. As a diluted solution with an oxidant concentration of 0 mg/L, artificial seawater that had been sterilized by filtration without ozone treatment was used. The aforementioned diluted solution (10 mL each) was placed in a sterilized 30 mL Erlenmeyer flask, and 0.1 mL of a bacterial cell liquid (about 2.3×10⁸ cells/mL) obtained by diluting 10 times an Escherichia coli (NBRC3972) liquid cultured overnight in a nutrient broth (NB) liquid medium was added thereto, and the mixture was incubated under the conditions of 37 °C, 150 rpm, 15 min. Each treated liquid was diluted 1000 times with physiological saline, and 0.1 mL of the diluted solution was applied to the surface of the LB solid medium in a plastic petri dish (diameter 85 mm), spread with a glass spreader, and then incubated at room temperature (23 °C) overnight in a static culture. After the culture, the number of viable Escherichia coli in the Erlenmeyer flasks (cells/mL) and the sterilization rate (%) were calculated by measuring the number of colonies formed on the LB solid medium, and are shown in Table 3.

TABLE 3

| oxidant concentration | | |
|---|---|---|
| (converted to ozone | | sterilization |
| concentration) | viable counts | rate |
| (mg/L) | (cells/mL) | (%) |
| 0 | 2280000 | 0 |
| 0.1 | 2260000 | 0.9 |
| 0.5 | 2240000 | 1.8 |
| 1.0 | 1220000 | 46.5 |
| 1.5 | 0 | 100 |
| 2.0 | 0 | 100 |

As shown in Table 3, when the oxidant concentration was 0.5 mg/L or less in terms of ozone concentration, almost no sterilizing effect on Escherichia coli was observed. However, when the oxidant concentration was 1.0 mg/L, the number of viable cells was almost halved, and when the oxidant concentration was 1.5 mg/L or more, the sterilization rate was 100%.

The above-mentioned results show that the system of Example 1 not only enables efficient and safe denitrification, but also makes it possible to efficiently sterilize miscellaneous bacteria including Escherichia coli in the rearing water.

### [Example 4] Decolorization Treatment of Rearing Water

In the treatment system of Example 1, sodium humate (Sigma-Aldrich, H16752) was added to the rearing water such that the absorbance at 450 nm was 0.035, and ozone treatment was performed by generating ozone fine bubbles with the ozone fine bubble generating device (8′) in the ozone treatment tank (3). The rearing water was treated in the same manner as in Example 1, except that the ozone treatment time was 15 minutes. At 90 minutes after the circulation by the auxiliary circulation pump (6) reached full circulation, the rearing water in the rearing tank (1) was collected and the absorbance at 450 nm was measured, and the decolorization rate was calculated using the following formula (I).

$$\begin{matrix}[ Math . 1 ] & \\ \begin{matrix}decolorization \\ rate ( \% )\end{matrix} = \frac{\begin{matrix}absorbance before start of ozone treatment - \\ absorbance after ozone treatment\end{matrix}}{absorbance before start of ozone treatment} \times 100 & ( I )\end{matrix}$$

The ozone treatment was repeated for seven sets, wherein one set is 120 minutes (2 hours) of the total treatment time of the batch manner treatment and the flow-through manner treatment in the ozone treatment tank (3). Since ammonium-nitrogen decreased with each set of ozone treatment, ammonium chloride was added to 0.5 ppm to 1 ppm to the rearing water before each set of ozone treatment to maintain the residual oxidant concentration in the rearing tank at less than 0.05 mg/L in terms of ozone.

After completion of the ozone treatment for each set, the decolorization rate of the rearing water was calculated and is shown in Table 4.

TABLE 4

| number of ozone treatments | decolorization |
|---|---|
| (total treatment time) | rate (%) |
| 1 (2 hr) | 28.6 |
| 2 (4 hr) | 45.7 |
| 3 (6 hr) | 57.1 |
| 4 (8 hr) | 68.6 |
| 5 (10 hr) | 77.1 |
| 6 (12 hr) | 85.7 |
| 7 (14 hr) | 90.0 |

As shown in Table 4, as the number of ozone treatments increased, the decolorization of the coloration caused by sodium humate progressed, and after 12 hours, a decolorization rate of 85% or more was achieved, which was evaluated as complete decolorization by visual observation.

During this treatment, the concentration of oxidant in the rearing tank (1) was always less than 0.05 mg/L in terms of ozone concentration, and no accumulation of nitrate-nitrogen was observed.

The above-mentioned results suggest that the system of Example 1 can efficiently and safely reduce ammonium-nitrogen in the rearing water while performing the decolorization treatment of the rearing water.

### [Example 5] Deodorization Treatment of Rearing Water

In the treatment system of Example 1, 15 individuals of Northern Sea Urchin with shell length of about 8 cm, one individual each of Japanese rockfish, black rockfish, and dark sleeper with body length of about 20 cm, and two individuals of Japanese fluvial sculpins with body length of about 10 cm were kept in the rearing tank (1) and reared for two months. When the ammonium-nitrogen concentration in the rearing water reached 1 ppm or more, ozone treatment was repeated until the ammonium-nitrogen concentration reached 0.5 ppm, wherein one set included 15 minutes of a batch manner treatment in the ozone treatment tank (3) and a total treatment time of 120 minutes (2 hours) of a subsequent flow-through manner treatment. Otherwise, the rearing water was treated in the same manner as in Example 1.

As the feed, a trout feed (“Trout Solid 4”, manufactured by Marubeni Nisshin Feed Co., Ltd.) was given every day to the fish at about 1% of the body weight of the fish, and dried kelp after rehydrating with water was given every day to Northern Sea Urchin in the amount that can be eaten in one day. The feces that occurred were collected and removed every day.

The intensity of odor generated from the upper part of the rearing tank (1) of this system was evaluated using an odor sensor (portable odor sensor mini XP-329m, manufactured by NEW COSMOS ELECTRIC CO., LTD.). The value immediately before the start of rearing was used as the base value, and the odor intensity after two months was evaluated.

After two months, the odor sensor value in the upper part of the rearing tank (1) only fluctuated in the first digit, and the fish odor peculiar to rearing was not detected sensorily.

During the rearing period, the oxidant concentration of the rearing water was always less than 0.05 mg/L in terms of ozone concentration, the nitrate-nitrogen concentration was several ppm, and the appearance of the rearing water was colorless and transparent. No single fish or shellfish died, and feed intake was also good.

The above-mentioned results show that the system of Example 1 can also perform decolorization and deodorization treatments while performing denitrification efficiently and safely.

### [Example 6] Killing Treatment of Plankton in Rearing Water

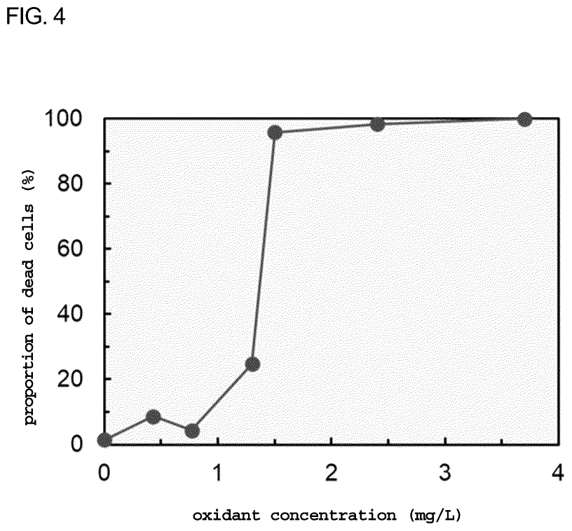

In the treatment system of Example 1, ozone treatment was performed by generating ozone fine bubbles to an oxidant concentration in the rearing water of 4.10 mg/L in terms of ozone concentration, by using the ozone fine bubble generating device (8′) for 60 L of rearing water in the ozone treatment tank (3). This treated water was sampled and diluted with artificial seawater, that had been sterilized by filtration without ozone treatment, to each oxidant concentration (in terms of ozone concentration) of 4.10 mg/L, 2.67 mg/L, 1.67 mg/L, 1.44 mg/L, 0.89 mg/L, or 0.44 mg/L. As a diluted solution with an oxidant concentration of 0 mg/L, artificial seawater that had been sterilized by filtration without ozone treatment was used. 1 mL of plankton (Chaetoceros gracilis, manufactured by YANMAR HOLDINGS CO., LTD.) stock solution was added to 9 mL of each aforementioned diluted solution of treated water (final oxidant concentration=3.7 mg/L, 2.4 mg/L, 1.5 mg/L, 1.3 mg/L, 0.8 mg/L, 0.4 mg/L, 0 mg/L) and the treatment was performed for 30 minutes. Then, 5 μL of 1 (w/v) % neutral red solution dissolved in ethanol was added to stain viable cells for 30 minutes. After concentrating each stained treated liquid by centrifugation, the staining status was observed with a camera-equipped microscope (culture microscope “CKX53-22PH-D” and digital camera for microscope DP23, manufactured by Olympus Corporation), the number of stained viable cells and the number of unstained dead cells were counted, and the proportion of dead cells in each diluted solution of treated water was calculated. The results are shown in FIG. 4.

As shown in FIG. 4, when the oxidant concentration exceeded 1.3 mg/L in terms of ozone concentration, the proportion of dead, unstained plankton cells increased rapidly, and it was observed that almost all plankton cells were killed at oxidant concentrations (converted to ozone concentration) of 1.5 mg/L or more.

The above-mentioned results demonstrate that the system of Example 1 not only enables efficient and safe denitrification, but also effectively kills plankton in the rearing water.

### INDUSTRIAL APPLICABILITY

As described in detail above, the present invention can provide a denitrification, sterilization, and decolorization system that can simultaneously achieve a high-concentration ozone treatment capable of efficiently performing decomposition of ammonium-nitrogen in rearing water, and sterilization and decolorization treatments of rearing water; and reduction of the oxidizing substances remaining in the treated water, and can efficiently perform removal of ammonium-nitrogen in rearing water and sterilization and clarification treatments of rearing water even under the environment where fishery products such as fish and shellfish are reared at high density, and a method for efficient denitrification, sterilization, and decolorization treatments of rearing water.

In addition, the present invention can provide a denitrification, sterilization, decolorization, deodorization, and plankton killing treatment system that can efficiently perform a deodorization treatment of rearing water and a killing treatment of plankton in rearing water, in addition to the removal of ammonium-nitrogen in rearing water and sterilization and clarification treatments of rearing water, as well as a method for denitrification, sterilization, decolorization, and deodorization treatments of rearing water and a method for a killing treatment of plankton in rearing water.

Therefore, the denitrification, sterilization, and decolorization system, the method for denitrification, sterilization, and decolorization treatments of rearing water, denitrification, sterilization, decolorization, deodorization, and plankton killing treatment system, the method for denitrification, sterilization, decolorization, and deodorization treatments of rearing water, and the method for a killing treatment of plankton in rearing water, of the present invention, are useful for land-based closed recirculating aquaculture of fishery products and for rearing fishery products in aquariums and the like, which require large amounts of rearing water, and can be effectively used in situations where decomposition of harmful plankton such as red tide and the like, and harmful components is required.

This application is based on a patent application No. 2022-123403 filed in Japan, the contents of which are incorporated in full herein.

### EXPLANATION OF SYMBOLS

1 rearing tank
2a physical filtration tank
2b physical filtration tank
3 ozone treatment tank
4 mixing tank.
5 main circulation pump
6 auxiliary circulation pump
7 partition
8 ozone supply device
8′ fine ozone bubble generating device
9 overflow pipe
10 fine bubble generating device
11 overflow water tank

1. A system for a denitrification, sterilization and decolorization treatment of rearing water, including a rearing tank, a physical filtration tank, an ozone treatment tank, a mixing tank, a main circulation pump and an auxiliary circulation pump, wherein the mixing tank is installed behind the ozone treatment tank, the main circulation pump is a pump that constantly circulates the rearing water through the rearing tank, the physical filtration tank, and the mixing tank, the auxiliary circulation pump is a pump that circulates the rearing water through the rearing tank, the physical filtration tank, the ozone treatment tank, and the mixing tank, and when the auxiliary circulation pump is stopped, the treatment of the rearing water in the ozone treatment tank is performed in a batch manner, and when the auxiliary circulation pump is operated, the treatment of the rearing water in the ozone treatment tank is performed in a flow-through manner.

2. The system according to claim 1, wherein the ozone treatment tank has an ozone supply device capable of supplying ozone fine bubbles.

3. The system according to claim 2, wherein the ozone supply device capable of supplying ozone fine bubbles is configured by connecting a fine bubble generating device composed of a fine bubble generating nozzle and a magnet pump to an ozone generator.

4. The system according to claim 1, wherein an ozone treatment tank and a mixing tank separated by a partition are installed above the rearing tank, the height of the partition is set higher than the water surface of the rearing water in the mixing tank, and when the auxiliary circulation pump is operated, the rearing water flows from the ozone treatment tank over the partition and into the mixing tank.

5. The system according to claim 4, wherein the ozone treatment tank and the mixing tank separated by the partition form an overflow water tank, and the mixing tank is connected to the rearing tank by an overflow pipe.

6. A method for treating rearing water, comprising, in a system for denitrification, sterilization, and decolorization treatments of rearing water, comprising a rearing tank, a physical filtration tank, an ozone treatment tank, a mixing tank installed behind the ozone treatment tank, a main circulation pump, and an auxiliary circulation pump, while constantly circulating the rearing water through the rearing tank, the physical filtration tank, and the mixing tank using the main circulation pump, stopping the operation of the auxiliary circulation pump that circulates the rearing water through the rearing tank, the physical filtration tank, the ozone treatment tank, and the mixing tank, treating the rearing water in the ozone treatment tank in a batch manner, operating the auxiliary circulation pump to treat the rearing water in the ozone treatment tank in a flow-through manner, and mixing the treated water after ozone treatment in the ozone treatment tank with rearing water circulated to the mixing tank by the main circulation pump to reduce oxidizing substances in the treated water in the ozone treatment tank and denitrify ammonium-nitrogen in the rearing water.

7. The treatment method according to claim 6, wherein the ozone treatment of the rearing water is performed using ozone fine bubbles.

8. The treatment method according to claim 7, wherein the ozone fine bubbles are supplied by an ozone supply device configured by connecting a fine bubble generating device composed of a fine bubble generating nozzle and a magnet pump to an ozone generator.

9. The treatment method according to claim 6, wherein the system for denitrification, sterilization, and decolorization of rearing water is a system in which an ozone treatment tank and a mixing tank separated by a partition are installed above the rearing tank, the height of the partition is set higher than the water surface of the rearing water in the mixing tank, and when the auxiliary circulation pump is operated, the rearing water flows from the ozone treatment tank over the partition and into the mixing tank.

10. The treatment method according to claim 9, wherein, in the system for denitrification, sterilization, and decolorization of rearing water, the ozone treatment tank and the mixing tank separated by the partition form an overflow water tank, and the mixing tank is connected to the rearing tank by an overflow pipe.

11. The system according to claim 1, which is a deodorizing treatment system for the rearing water or a treatment system for killing plankton in the rearing water.

12. The system according to claim 4, which is a deodorizing treatment system for the rearing water or a treatment system for killing plankton in the rearing water.

13. The system according to claim 5, which is a deodorizing treatment system for the rearing water or a treatment system for killing plankton in the rearing water.

14. The treatment method according to claim 6, further comprising a sterilization treatment or a decolorization treatment of rearing water.

15. The treatment method according to claim 9, further comprising a sterilization treatment or a decolorization treatment of rearing water.

16. The treatment method according to claim 10, further comprising a sterilization treatment or a decolorization treatment of rearing water.

17. The treatment method according to claim 6, wherein the system is a deodorization treatment system for rearing water or a plankton killing treatment system for rearing water, and the method further comprises performing a deodorization treatment or a plankton killing treatment of rearing water.

18. The treatment method according to claim 9, wherein the system is a deodorization treatment system for rearing water or a plankton killing treatment system for rearing water, and the method further comprises performing a deodorization treatment or a plankton killing treatment of rearing water.

19. The treatment method according to claim 10, wherein the system is a deodorization treatment system for rearing water or a plankton killing treatment system for rearing water, and the method further comprises performing a deodorization treatment or a plankton killing treatment of rearing water.
